(19) United States
(12) Patent Application Publication
(10) Pub. No.: US 2015/0178867 A1
(43) Pub. Date: Jun. 25, 2015

(54) Linked Addendum Detection

(71) Applicant: Seal Software Ltd., Godalming (GB)

(72) Inventor: Kevin Gidney, Oslo (NO)

(73) Assignee: Seal Software Ltd., Godalming (GB)

(21) Appl. No.: 14/140,442

(22) Filed: Dec. 24, 2013

(51) Int. Cl. G06Q 50/18; G06Q 10/10

(52) U.S. Cl. CPC G06Q 50/18; G06Q 10/10

(57) ABSTRACT

A linked addendum detection system identifies and links related contractual documents including a master agreement (MA) and associated amendments from a large volume of data. The system extracts primary features including key references or descriptions within each contractual document. In addition, the system also includes grouping to detect the related contractual documents. Moreover, the system sorts the MA and the associated amendments according to the modification time (MTIME), and further sequentially establishes linkages from one contractual document to the next document in order. Furthermore, the system prepares and provides output result for display to an end user.

### BACKGROUND

1. Field of Art

The disclosure generally relates to the field of data management, and in particular to identifying and linking related documents.

2. Description of the Related Art

Over time, parties involved in contracts may renegotiate for changes in the contracts based on new requirements or variations within law. Conventionally, instead of issuing or creating a new contract, parties involved create amendments or addendums to an existing master agreement (MA). In most cases, the amendments contain only the details that are to be changed with very little information from the MA. Thus, without the structured filing and tracking system of related contractual documents including the MA and the amendments associated with the MA, the related contractual documents may easily become separated. This separation means that future references to the contract could be referring to old or inconsistent data, exposing any parties not keeping track of the amendments or the addendums to a significant amount of risk of overlooking the amendments and critical information contained within them.

Conventional approaches manually keep track of related contracts and amendments. However, conventional approaches can be unreliable due to human errors and also can be a manual time consuming process.

Accordingly, there is a need for an automated method for identifying and linking related contractual documents.

### BRIEF DESCRIPTION OF DRAWINGS

The disclosed embodiments have advantages and features which will be more readily apparent from the detailed description, the appended claims, and the accompanying figures (or drawings). A brief introduction of the figures is below.

FIG. 1 illustrates a method of detecting related contractual documents.

FIG. 2 illustrates a detailed method of grouping to identify related contractual documents.

FIGS. 3-4 illustrate an example of grouping and linking the related contractual documents.

FIG. 5 illustrates one embodiment of system architecture for linked addendum detection.

FIG. 6 illustrates a system for an input processor configured to process input data.

FIG. 7 illustrates a system for a discovery engine to properly structure and to normalize the input data.

FIG. 8 illustrates an embodiment of an analysis engine configured to identify the related contractual documents and to sequentially link the related contractual documents in order.

FIG. 9 illustrates one embodiment of components of an example machine able to read instructions from a machine-readable medium and execute them in a processor (or controller).

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

A document processing system (and method) includes a linked addendum detection system that detects related contractual documents including a master agreement (MA) and associated amendments from raw input data. The linked addendum detection system further sequentially links the related contractual documents in chronological order.

One embodiment of a disclosed configuration also includes a method (and system) of identifying and linking the related contractual documents. The method allows identification of amendments with direct references to the MA, containing same information from the MA. In addition, the method allows identification of amendments with indirect references to the MA, containing same information from the amendments with direct references to the MA, but not from the MA itself. The method includes extracting primary features including key references or descriptions within each contractual document. The method also includes grouping to find the related contractual documents, and sequentially establishing linkages of the related contractual documents according the creation time of the document.

### Example Linked Addendum Detection Method

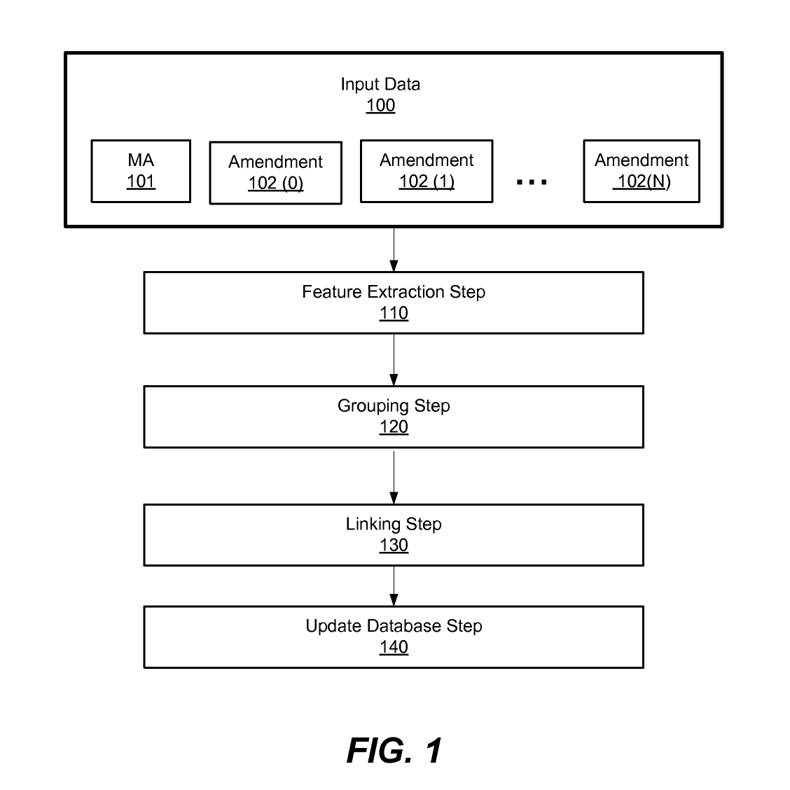

FIG. 1 illustrates a flow chart for linked addendum detection to detect and link the related contractual documents. Specifically, the linked addendum detection includes a feature extraction step 110, a grouping step 120, a linking step 130 and an update database step 140.

As illustrated in FIG. 1, the feature extraction step 110 receives one or more input data 100 including contractual documents such as a master agreement (MA) 101, an amendment 102 (0), an amendment 102(1) . . . an amendment 102(N) (generally 102). Also, the feature extraction step 110 extracts primary features, which can be key references or descriptions that can describe the contractual document and the information held within. The primary features include, but are not limited to, a contract type, a contract class, reference dates, and a modification time (MTIME). The modification time refers to the time when the contractual document is created, as contractual documents are image files or non-changeable PDF's. It is to be noted that the modification time is distinct from a change time (CTIME). For example, whenever changing a file permission or moving a file to another file system, the change time is updated whereas the modification time remains the same. The reference dates further include an effective date, a signature date, and a termination date. In one exemplary embodiment, the feature extraction step 110 obtains a contract type and a contract class first, which both indicate whether a document is the MA 101 or the amendment 102. Further, the feature extraction step 110 obtains additional primary features including a reference date and a start time from each of the contractual document. Alternatively, the feature extraction step 110 obtains primary features in any order. The feature extraction step 110 utilizes at least one of a natural language engine, a machine learning engine or rule sets to obtain the primary features.

Following the feature extraction step 110, the grouping step 120 identifies the related contractual documents. In addition, the linking step 130 sorts the MA 101 with the amendments 102 in the related documents by the modification time, and further sequentially establishes linkages (e.g. associations) from one contractual document to another. Moreover, the update database step 140 updates the database.

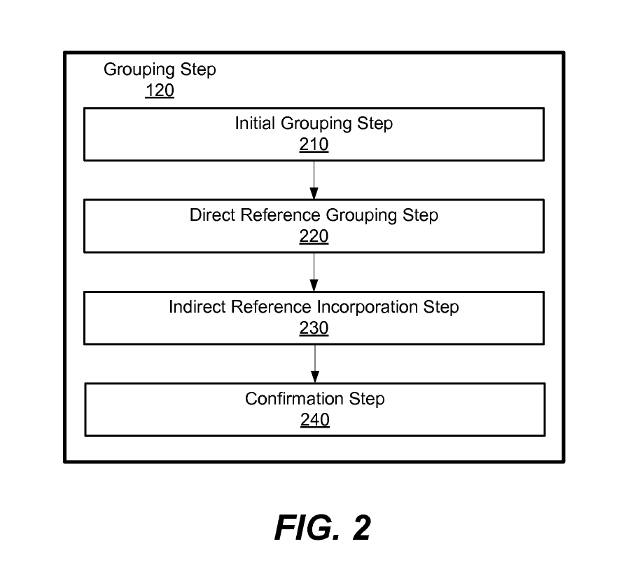

Referring to FIG. 2, illustrated is the grouping step 130 in detail. The grouping step 130 includes an initial grouping step 210, a direct reference grouping step 220, an indirect reference incorporation step 230, and a confirmation step 240. The initial grouping step 210 builds a feature space matrix with the extracted primary features, and then groups the contractual documents into a primary group and a secondary group by the contract type and the contract class. The primary group includes the MA 101, whereas the secondary group includes the amendments 102.

After the initial group step 210, the direct reference grouping step 220 further divides the amendments 102 in the secondary group into a related group and a non-related group by comparing the reference dates. Specifically, the direct reference grouping step 220 compares each of the reference dates of the amendments 102 in the related group with each of the reference dates of the MA 101, then classifies the amendments 102 into the related group if there is at least one matching reference date. Hence, the direct reference grouping step 220 classifies the amendments 102 with direct references to the MA. Furthermore, if there is no matching reference dates, then the direct reference grouping step 220 classifies the amendment 102 into the non-related group.

Moreover, the indirect reference incorporation step 230 finds additional related contractual documents and includes the related contractual documents into the related group by comparing the reference dates. Specifically, the indirect reference incorporation step 230 compares each of the reference dates of the amendments 102 in the non-related group with each of the reference dates of the amendments 102 in the related group, and if there is at least one matching reference date, incorporates the amendments 102 in the non-related group into the related group. Hence, the indirect reference incorporation step 230 can incorporate the amendments 102 with indirect references to the MA into the related group. Anytime the amendment 102 from the non-related group is incorporated into the related group, the indirect reference incorporation step 230 compares all the remaining amendments in the non-related group, because the recently incorporated amendment 102 may include the reference dates that have not be compared before.

The confirmation step 240 identifies any incorrect grouping from the direct reference grouping step 220 and the indirect reference incorporation step 230 by comparing the modification time. The confirmation step 240 excludes the amendment 102 with the modification time prior to the start date of the MA from the related group and incorporates it into the non-related group.

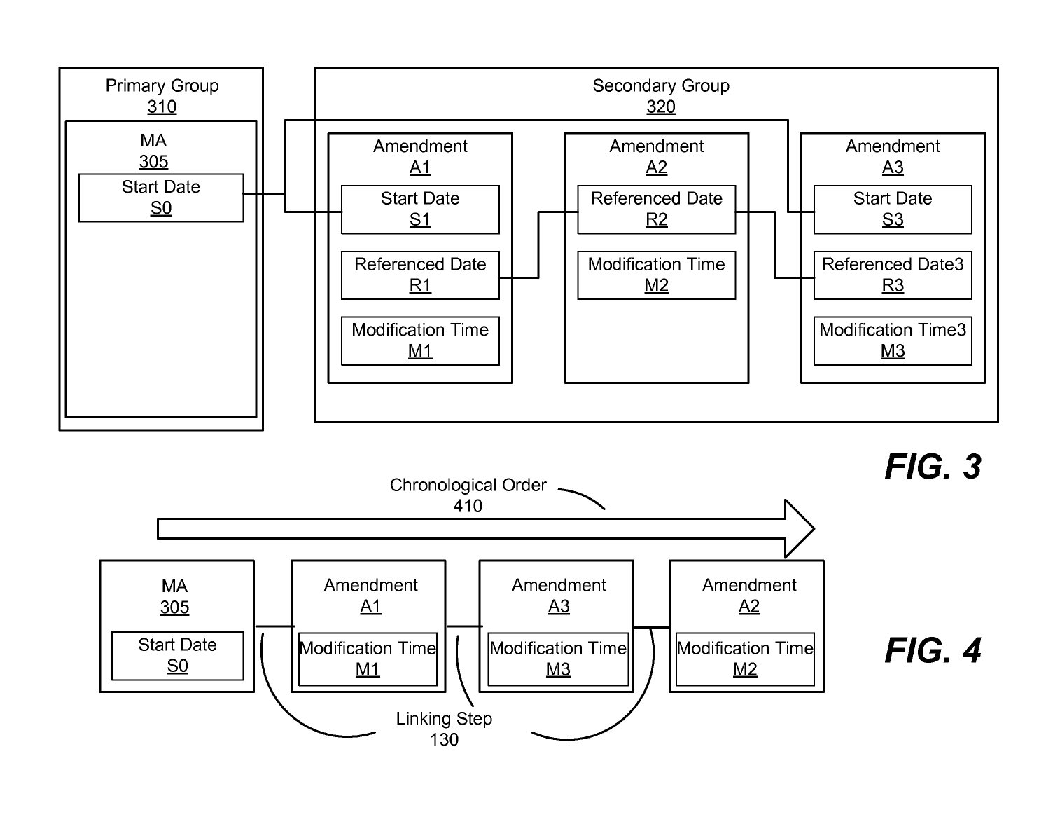

Referring to FIG. 3 and FIG. 4, illustrated are an example of the operation of the grouping step 130 and the linking step 140. In this example, input documents include a MA 305, and three amendments: A1, A2 and A3. After obtaining the primary features, the initial grouping step 210 builds the feature space matrix, and places the MA 305 in the primary group 310 and the three amendments A1, A2 and A3 in the secondary group 320. In addition, the direct reference grouping step 220 places the amendments A1 and A3 in the related group (not shown), because a start date S0 of the MA 305 is the same as a start date S1 of the amendment A1 and a start date S3 of the amendment A3 (i.e., S0=S1=S3). Additionally, the indirect reference incorporation step 230 includes the amendment A2 into the related group, as a reference date R2 of the amendment A2 is the same as a reference date R1 of the amendment A1 and a reference date R3 of the amendment the A3 (i.e., R1=R2=R3). The confirmation step 240 verifies that modification time M1, M2 and M3 are after the start date S0 of the MA 305.

In FIG. 4, illustrated is the linking step 140 of the above example. The linking step 140 sorts the MA 305 and the amendments A1, A2 and A3 in chronological order 410 according to the modification time M1, M2, and M3. In this example, the MA 305 is followed by the amendment A1, and then subsequently followed by the amendment A3, and the amendment A2, because the modification time M1 is the earliest and the modification time M2 is the latest (i.e., M1<M3<M2). Moreover, the linking step 140 establishes linkages such that each contractual document links to the subsequent contractual document in the chronological order 410.

It is to be noted that the related amendments identified from the disclosed configuration may include unassociated contracts with the MA 101. An end user may easily correct the mistakenly placed linkage, because the linked contractual documents are in a manageable size compared to corpus amount of original data. In addition, the example embodiment provides an advantage of quickly locating related contractual documents from a large volume of data and presenting it to the end user.

### Example Linked Addemdum Detection System

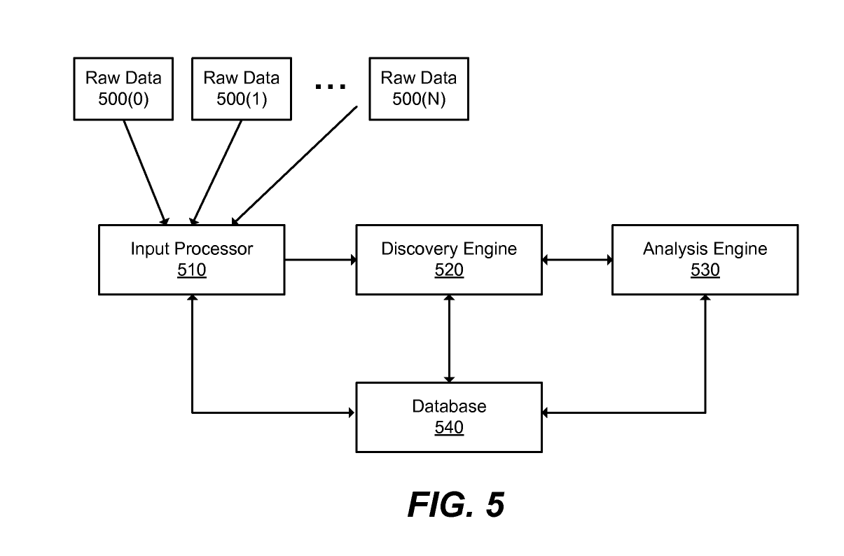

FIG. 5 illustrates one exemplary embodiment of the linked addendum detection system to identify the related contractual documents and to sequentially link the related contractual documents. The linked addendum detection system includes one or more input processors (generally an input processor 510), a discovery engine 520, an analysis engine 530, and a database 540. As illustrated in FIG. 5, the input processor 510 aggregates one or more raw data 500(0), 500(1) . . . 500(N) (generally 500) and processes the raw data 500 in an appropriate format. Also, the discovery engine 520 is communicatively coupled to the input processor 510. In addition, the analysis engine 530 is coupled to the discovery engine 520. The discovery engine 520 develops predefined features and initial search results. The predefined features can be a pre-generated key reference or a descriptive verb that can describe the document and the information held within. Additionally, the analysis engine 530 performs core functions of detecting and linking the related contractual documents. Throughout the process the database 540 stores the initial search results, metadata, and the predefined features. In addition, the database 540 is communicatively coupled to the input processor 510, the discovery engine 520, and the analysis engine 530.

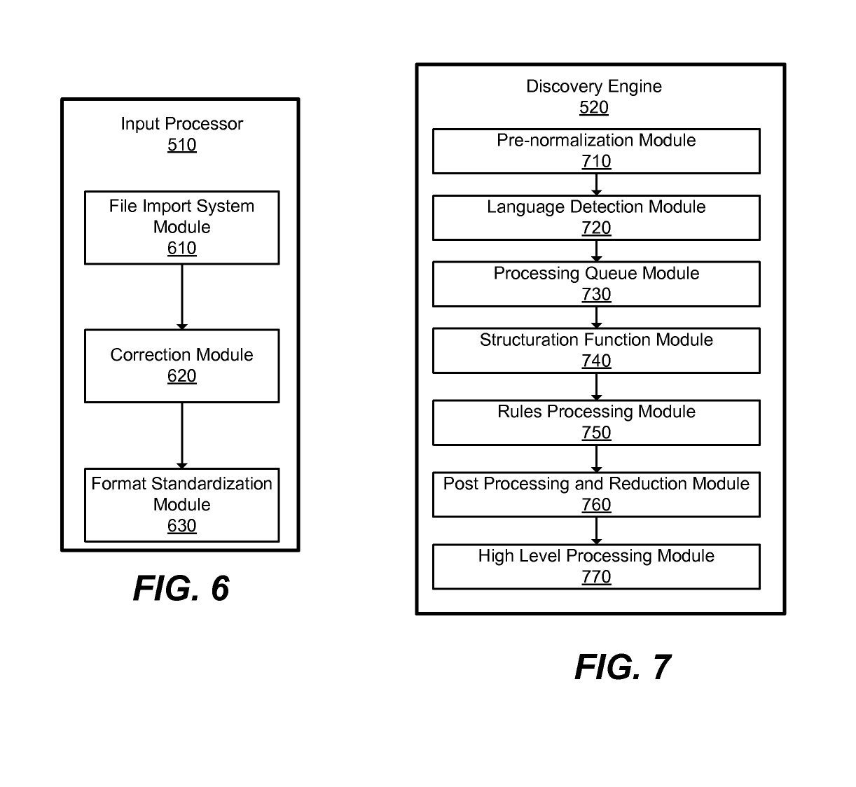

Turning to FIG. 6, it illustrates an exemplary embodiment of an input processor 510 that aggregates the raw data 500, and refines the raw data 500 into acceptable formats in the following modules. As shown in FIG. 6, the input processor 510 includes a file import system module 610, a correction module 620, and a format standardization module 630.

The file import system module 610 receives the raw data 500 from any one of file systems, emails, Content Management Systems (CMS) and physical document scanning devices. The file import system module 610 also detects potential contracts and checks if any duplicates of documents exist in the database 540 already. In addition, the file import system module 610 can convert a physical document into another electronic format, for example Portable Document Format (PDF), Microsoft Office format, Tagged Image File Format (TIFF), Graphics Interchange Format (GIF), Join Photographic Experts Group (JPEG) and etc. Moreover, the file import system module 610 may include an image file processor module with an optical character recognition (OCR) engine (not shown). The OCR engine may be an ABBYY fine reader engine or a standard iFilter OCR engine. It is to be noted that other types of OCR engine or any combinations of OCR modules may be implemented. Furthermore, the file import system module 610 detects the language of the contractual document and how many words exist within.

The correction module 620 in the input processor 510 receives the data imported from the file import system module 610. The correction module 620 also is configured to apply typographical corrections or OCR corrections.

In an exemplary embodiment, the format standardization module 630 tailors the format of the data imported from the file import system module 610 for further processing. The format standardization module 630 applies filters to extract textual information. In addition, the input processor 510 may remove passwords to access a protected contractual document only when the owners of the documents agree to remove such passwords. Furthermore, the format standardization module 630 includes a file protection function that creates copies of potential contractual documents identified. These identified contractual documents are stored in the database 540 with security access attributes.

Next, FIG. 7 illustrates an embodiment of the discovery engine 520 that structurally analyzes an input data from the input processor 510 and generates the predefined features. The predefined features include, but are not limited to, a predefined contract type, a predefined contract class, a predefined reference dates and a predefined modification time. The predefined reference dates further include a predefined start date, a predefined effective date, a predefined signature date, and a predefined termination date.

The discovery engine 520 also applies the predefined features into the search engine (not shown) and prepares the initial search results along with the predefined features and metadata in a format that allows the end user to view. As shown in FIG. 7, the discovery engine 520 includes a pre-normalization module 710, a language detection module 720, a processing queue module 730, a structuration function module 740, a rules processing module 750, a post processing and reduction module 760, and a high level processing module 770.

The pre-normalization module 710 receives the imported data in the standardized format obtained from the input processor 510, and converts the imported data into the standard XML or HyperText Markup Language (HTML) document. Also, the language detection module 720 can identify the language used in the XML or HTML converted document (e.g., English, German, and etc.), and place the document in the processing queue module 730.

Once the XML or HTML converted document is out of the processing queue module 730, the structuration function module 740 structurally analyzes the XML or HTML converted document into a plurality of hierarchical levels, including a sentence level, a paragraph level, a section level, and a document level. Analyzing the documents or data in the structure mentioned above allows locating of terminologies and clauses used in the contractual documents.

Following the structuration function module 740 is the rules processing module 750. In this stage, the discovery engine 520 applies predefined rules to generate the predefined features. The predefined rules determine the logic or sequence of words, sentences, phrases, NLP (natural language processing) features, or terminologies. In addition, the rules processing module 750 generates the predefined features from the predefined rules for the end user to customize in the analysis engine 530.

In addition, the post processing and reduction module 760 reduces and normalizes the predefined features from the rules processing module 750. It is to be noted that in addition to sentence and paragraph boundaries, the discovery engine 520 can identify contractual section boundaries such as termination, limitation of liability, indemnity sections of a contract, and etc. Moreover, the post processing and reduction module 760 prepares the predefined features for the end user to customize in the analysis engine 530.

Normalization in the post processing and reduction module 760 reduces the common notations into a standard format. For instance, the same date can be expressed in multiple ways (e.g. Oct. 23rd 1992, October 23, 1992, 10/23/1992, 23/10/1992, 1992/10/23 and etc.), and the normalization can convert various formats into standard ISO format. Normalizing to the standard format can eliminate confusions and improve processing speed. Most importantly, by consolidating into same notations, the discovery engine 520 can reduce any duplicate terms in different formats.

After the feature creation and normalization, the high-level processing module 770 creates metadata and stores them in the database 540. Additionally, the search engine (not shown) communicatively coupled to the database 540 obtains initial search results. Moreover, the high level processing 770 prepares the predefined features as well as the initial search results in a format that the end user can view. Furthermore, either one or both of an internal search engine (not shown) and an external search engine (not shown) may perform a search function.

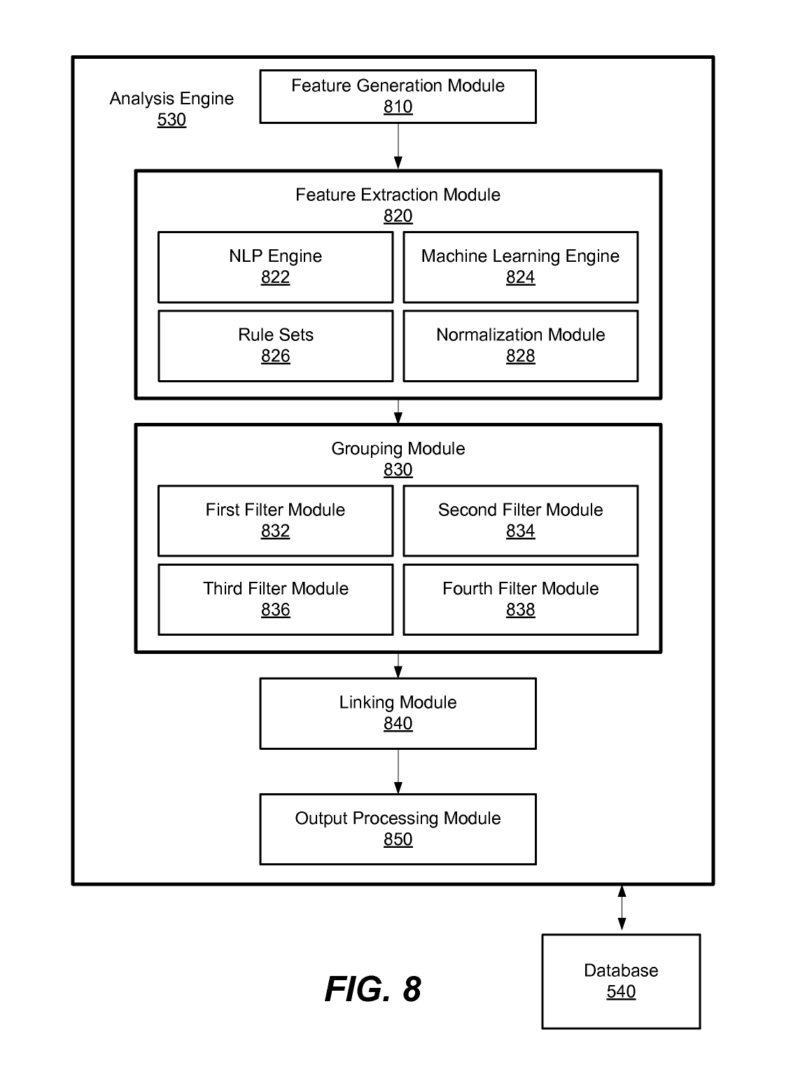

Referring to FIG. 8, illustrated is the analysis engine 530 further including a feature generation module 810, a feature extraction module 820, a grouping module 830, a linking module 840 and an output processing module 850.

In one exemplary embodiment, the feature generation module 810 may use the predefined features as primary features without the end user defining the primary features. The primary features can be a key reference or a descriptive verb to be applied in the feature extraction module 820 that can describe the document and the information held within. Alternatively, the feature generation module 810 may allow the end user to define the primary features based on the predefined features.

Following the feature generation module 810, the feature extraction module 820 extracts the primary features from the contractual documents and stores the extracted primary features in the database 540. The primary features include, but are not limited to, a contract type, a contract class, a reference dates and a modification time. The reference dates further include a start date, an effective date, a signature date, and a termination date. As illustrated in FIG. 8, the feature extraction module 820 may further include at least any one of a natural language processing (NLP) engine 822, a machine learning engine 824 and rule sets 826. The feature extraction module 820 may include a normalization module 828 configured to reduce the common notations into a standard format.

After the feature extraction module 820 obtains the primary features, the grouping module 830 identifies the related contractual documents. In FIG. 8, the grouping module 830 includes a first filter module 832, a second filter module 834, a third filter module 836 and a fourth filter module 838.

In an exemplary embodiment, the grouping module 830 builds a feature space matrix with pointers to the corresponding primary features in the database 540, and then identifies the related contractual documents with the pointers to reduce the extra storage requirement. Alternatively, the primary features themselves or the copies may be compared and transferred in the database 540 to identify the related contractual documents.

Within the grouping module 830, the first filter module 832 separates the contractual documents into the MA 101 and the amendments 102 by comparing the contract type and the contract class. After the first filter module 832, the second filter module 834 divides the amendments 102 in the secondary group into a related group and a non-related group by comparing the reference dates. Specifically, the second filter module 834 compares each of the reference dates of the amendments 102 in the related group with each of the reference dates of the MA 101, and then classifies the amendments 102 into the related group if there is at least one matching reference date. Thus, the second filter module 834 classifies the amendments 102 with direct references to the MA. Furthermore, if there is no matching reference dates, then the second filter module 834 classifies the amendment 102 into the non-related group.

Moreover, the third filter module 836 finds additional related contractual documents and includes the related contractual documents into the related group by comparing the reference dates. Specifically, the indirect reference incorporation step 836 compares each of the reference dates of the amendments 102 in the non-related group with each of the reference dates of the amendments 102 in the related group. The process incorporates the amendments 102 in the non-related group into the related group if there is at least one matching reference date. Hence, the third filter module 836 incorporates the amendments 102 with indirect references to the MA into the related group. Anytime the amendment 102 from the non-related group is incorporated into the related group, the third filter module 836 compares all the remaining amendments in the non-related group, because the recently incorporated amendment 102 may include the reference dates that have not be compared before.

Furthermore, the fourth filter module 838 identifies any incorrect grouping from the previous filters by comparing the modification time. Specifically, the fourth filter module 838 excludes the amendment 102 with the modification time prior to the start date of the MA from the related group and incorporates it into the non-related group.

Moreover, once the related contractual documents are identified from the grouping module 830, the linking module 840 sorts the MA 101 with the amendments 102 in the related group according to the modification time. In addition, the linking module 840 further sequentially establishes linkages (e.g. associations) from one contractual document to the next document in order. In addition, the output processing module 850 updates the database 540 and provides output data for display to the end user.

### Computing Machine Architecture

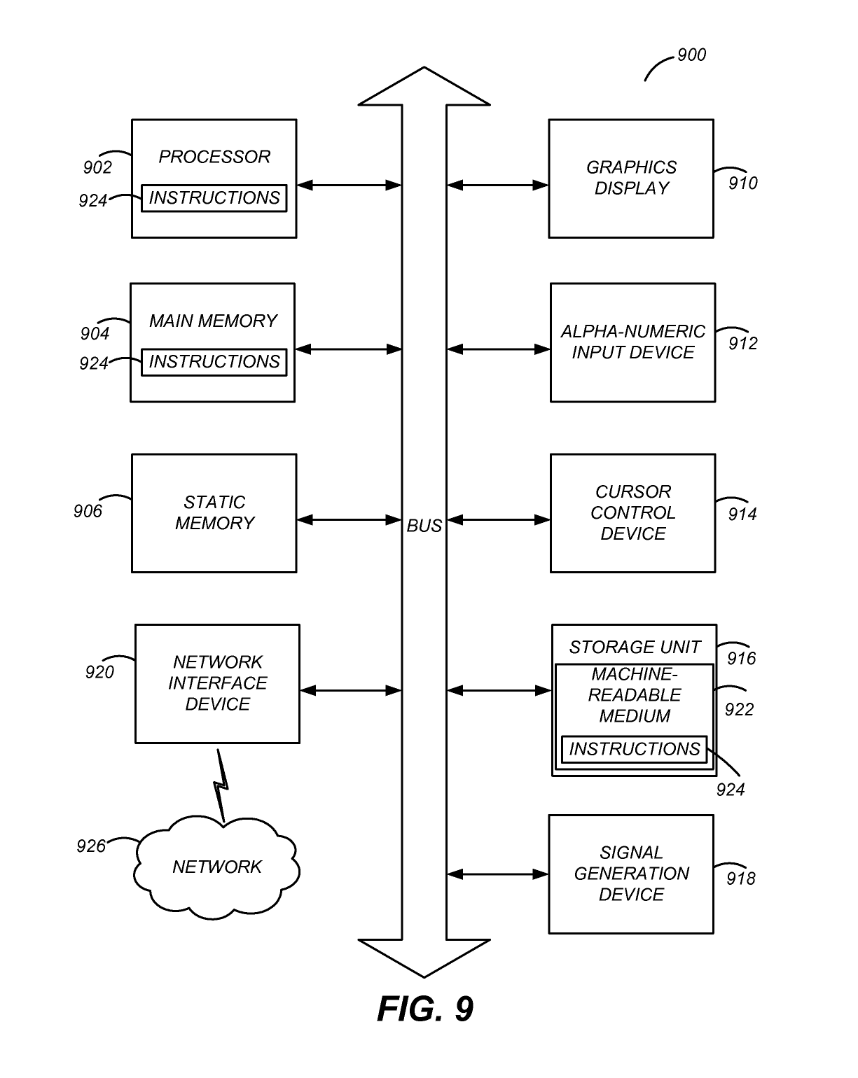

FIG. 9 is a block diagram illustrating components of an example machine able to read instructions from a machine-readable medium and execute them in a processor (or controller). Specifically, FIG. 9 shows a diagrammatic representation of a machine in the example form of a computer system 900 within which instructions 924 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 924 (sequential or otherwise) that specify actions to be taken by that machine. Further, while only a single machine is illustrated, the term “machine” shall also be taken to include any collection of machines that individually or jointly execute instructions 924 to perform any one or more of the methodologies discussed herein.

The example computer system 900 includes a processor 902 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 904, and a static memory 906, which are configured to communicate with each other via a bus 908. The computer system 900 may further include graphics display unit 910 (e.g., a plasma display panel (PDP), a liquid crystal display (LCD), a projector, or a cathode ray tube (CRT)). The computer system 900 may also include alphanumeric input device 912 (e.g., a keyboard), a cursor control device 914 (e.g., a mouse, a trackball, a joystick, a motion sensor, or other pointing instrument), a storage unit 916, a signal generation device 918 (e.g., a speaker), and a network interface device 920, which also are configured to communicate via the bus 908.

The storage unit 916 includes a machine-readable medium 922 on which is stored instructions 924 (e.g., software) embodying any one or more of the methodologies or functions described herein. The instructions 924 (e.g., software) may also reside, completely or at least partially, within the main memory 904 or within the processor 902 (e.g., within a processor's cache memory) during execution thereof by the computer system 900, the main memory 904 and the processor 902 also constituting machine-readable media. The instructions 924 (e.g., software) may be transmitted or received over a network 926 via the network interface device 920.

While machine-readable medium 922 is shown in an example embodiment to be a single medium, the term “machine-readable medium” should be taken to include a single medium or multiple media (e.g., a centralized or distributed database, or associated caches and servers) able to store instructions (e.g., instructions 924). The term “machine-readable medium” shall also be taken to include any medium that is capable of storing instructions (e.g., instructions 924) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

It is noted that although the configurations as disclosed are in the context of contracts, the principles disclosed can apply to analysis of other documents that can include data corresponding to specific terminologies or clauses related to another document. Advantages of the disclosed configurations include promptly identifying related documents and establishing linkages in a large volume of documents. The advantages also include allowing an end user to extract and manage the related documents in a manageable size compared to corpus amount of original data. Moreover, while the examples herein were in the context of a contract document, the principles described herein can apply to other documents, including web pages, having any linkages or associations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated in FIGS. 1-8. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 902, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for linked addendum detection through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer implemented method of identifying, ordering and linking a related portion of a plurality of contractual documents, the plurality of contractual documents comprised of a master agreement (MA) and a plurality of amendments, the method comprising:
initially grouping, by one or more processors, by a contract class the plurality of contractual documents into a primary group comprising the MA and a secondary group comprising the plurality of amendments;
generating a sub-grouping, by the one or more processors, by reference dates comprising a start date, an effective date, a signature date, and a termination date, the plurality of amendments in the secondary group from the initial grouping into a related group and a non-related group, at least one of the reference dates of each of the plurality of amendments in the related group equal to at least one of the reference dates of the MA, none of the reference dates of each of the plurality of amendments in the non-related group equal to any of the reference dates of the MA;
incorporating, by the one or more processors, a related portion of the plurality of amendments in the non-related group from the sub-grouping into the related group, at least one of the reference dates of the related portion of the plurality of amendments in the non-related group from the sub-grouping equal to at least one of the reference dates of one of the plurality of amendments in the related group;
excluding, by the one or more processors, a non-related portion of the plurality of amendments in the related group from the incorporation by comparing the start date of the MA and modification time (MTIME) of the plurality of amendments in the related group from the incorporation comprising first amendments and second amendments, each of the first amendments having at least one of the reference dates equal to at least one of the reference dates of the MA, each of the second amendments having at least one of the reference dates equal to at least one of the reference dates of another amendment from the first amendments or the second amendments but not of the MA, the MTIME of the non-related portion of the plurality of amendments in the related group from the incorporation earlier than the start date of the MA;
ordering, by the one or more processors, the MA and the plurality of amendments in the related group from the exclusion chronologically based on the MTIME;
linking, by the one or more processors, the MA and the plurality of amendments in the related group from the ordering; and
providing, automatically by the one or more processors, for display outputs comprising the related portion of the plurality of amendments, the related portion of the plurality of amendments further comprising the MA and the plurality of amendments in the related group from the linking.

2-4. (canceled)

5. A computer implemented method of identifying, ordering and linking a related portion of a plurality of contractual documents, the plurality of contractual documents comprised of a master agreement (MA) and a plurality of amendments, the method comprising:
grouping, by one or more processors, by reference dates the plurality of amendments into a related group and a non-related group, at least one of the reference dates of each of the plurality of amendments in the related group equal to at least one of the reference dates of the MA, none of the reference dates of each of the plurality of amendments in the non-related group equal to any of the reference dates of the MA;
incorporating, by the one or more processors, a related portion of the plurality of amendments in the non-related group from the grouping into the related group, at least one of the reference dates of the related portion of the plurality of amendments in the non-related group from the grouping equal to at least one of the reference dates of one of the plurality of amendments in the related group;
excluding, by the one or more processors, a non-related portion of the plurality of amendments in the related group from the incorporation by comparing the reference dates of the MA and modification time (MTIME) of the plurality of amendments in the related group from the incorporation comprising first amendments and second amendments, each of the first amendments having at least one of the reference dates equal to at least one of the reference dates of the MA, each of the second amendments having at least one of the reference dates equal to at least one of the reference dates of another amendment from the first amendments or the second amendments but not of the MA, the MTIME of the non-related portion of the plurality of amendments in the related group from the incorporation earlier than the reference dates of the MA; and
ordering and linking, chronologically by the one or more processors, the MA and the plurality of amendments in the related group from the exclusion based on the MTIME.

6. The method of claim 5, wherein the reference dates comprise a start date, an effective date, a signature date, and a termination date.

7. The method of claim 6, further comprising grouping by a contract class the plurality of contractual documents into a primary group comprising the MA and a secondary group comprising the plurality of amendments.

8. The method of claim 5, further comprising providing for display outputs comprising the related portion of the plurality of amendments.

9. (canceled)

10. A system for identifying, ordering and linking a related portion of a plurality of contractual documents, the plurality of contractual documents comprised of a master agreement (MA) and a plurality of amendments, the system comprising:
a storage comprising a non-transitory compute readable medium storing a program of executable instructions; and
a processor that executes the program of executable instructions to:
group by reference dates the plurality of amendments into a related group and a non-related group, at least one of the reference dates of each of the plurality of amendments in the related group equal to at least one of the reference dates of the MA, none of the reference dates of each of the plurality of amendments in the non-related group equal to any of the reference dates of the MA;
incorporate a related portion of the plurality of amendments in the non-related group from the grouping into the related group, at least one of the reference dates of the related portion of the plurality of amendments in the non-related group from the grouping equal to at least one of the reference dates of one of the plurality of amendments in the related group; and
exclude a non-related portion of the plurality of amendments in the related group from the incorporation by comparing the reference dates of the MA and modification time (MTIME) of the plurality of amendments in the related group from the incorporation comprising first amendments and second amendments, each of the first amendments having at least one of the reference dates equal to at least one of the reference dates of the MA, each of the second amendments having at least one of the reference dates equal to at least one of the reference dates of another amendment from the first amendments or the second amendments but not of the MA, the MTIME of the non-related portion of the plurality of amendments in the related group from the incorporation earlier than the reference dates of the MA;
chronologically order and link the MA and the plurality of amendments in the related group from the exclusion based on the MTIME.

11. The system for claim 10, wherein the processor executes the instructions to:
provide, for display, the related portion of the plurality of contractual documents in order.

12. The system for claim 11, wherein the reference dates comprise a start date, an effective date, a signature date, and a termination date.

13. The system for claim 12, wherein the processor executes the instruction to group by a contract class the plurality of contractual documents into a primary group comprising the MA and a secondary group comprising the plurality of amendments.

14-16. (canceled)

17. A non-transitory computer readable medium configured to store program code, the program code configured to identify, order and link a related portion of a plurality of contractual documents, the program code comprising instructions that when executed by a processor cause the processor to:
group by reference dates a plurality of amendments of the plurality of contractual documents into a related group and a non-related group, at least one of the reference dates of each of the plurality of amendments in the related group equal to at least one of the reference dates of a master agreement (MA) of the plurality of contractual documents, none of the reference dates of each of the plurality of amendments in the non-related group equal to any of the reference dates of the MA;
incorporate a related portion of the plurality of amendments in the non-related group from the grouping into the related group, at least one of the reference dates of the related portion of the plurality of amendments in the non-related group from the grouping equal to at least one of the reference dates of one of the plurality of amendments in the related group;
exclude a non-related portion of the plurality of amendments in the related group from the incorporation by comparing the reference dates of the MA and modification time (MTIME) of the plurality of amendments in the related group from the incorporation comprising first amendments and second amendments, each of the first amendments having at least one of the reference dates equal to at least one of the reference dates of the MA, each of the second amendments having at least one of the reference dates equal to at least one of the reference dates of another amendment from the first amendments or the second amendments but not of the MA, the MTIME of the non-related portion of the plurality of amendments in the related group from the incorporation earlier than the reference dates of the MA; and
order and link chronologically, the MA and the plurality of amendments in the related group from the exclusion based on the MTIME.

18. The non-transitory computer readable medium of claim 17, wherein the reference dates comprise a start date, an effective date, a signature date, and a termination date.

19. The non-transitory computer readable medium of claim 18, further comprise instructions that when executed by the processor cause the processor to:
group by a contract class the plurality of contractual documents into a primary group comprising the MA and a secondary group comprising the plurality of amendments.

20. The non-transitory computer readable medium of claim 17, further comprising the program code that cause the processor to provide for display an output to an end user, the output comprising the related portion of the plurality of contractual documents.

21. (canceled)
